(19) United States
(12) Patent Application Publication
(10) Pub. No.: US 2025/0287260 A1
(43) Pub. Date: Sep. 11, 2025

(54) ELECTRONIC DEVICE FOR SWITCHING CELLULAR COMMUNICATION ON BASIS OF STATE OF ELECTRONIC DEVICE, AND OPERATION METHOD FOR ELECTRONIC DEVICE

(71) Applicant: Samsung Electronics Co., Ltd., Suwon-si (KR)

(72) Inventor: Hyunchul LEE, Suwon-si (KR)

(21) Appl. No.: 19/219,611

(22) Filed: May 27, 2025

Related U.S. Application Data
(63) Continuation of application No. PCT/KR2023/014981, filed on Sep. 27, 2023.

(30) Foreign Application Priority Data
Dec. 7, 2022 (KR) 10-2022-0169764
Jan. 2, 2023 (KR) 10-2023-0000118

(51) Int. Cl. H04W 28/08; H04W 28/02; H04W 76/10; H04W 88/06

(52) U.S. Cl. CPC H04W 28/0846; H04W 28/0236; H04W 76/10; H04W 88/06

(57) ABSTRACT

An electronic device is provided. The electronic device includes a first communication circuit for supporting at least one of first cellular communication or second cellular communication, a second communication circuit for supporting short-range wireless communication, memory, comprising one or more storage media, storing instructions; an application processor coupled to the memory, and a communication processor coupled to the memory, wherein the instructions, when executed by the application processor, cause the electronic device to check whether the electronic device satisfies, in a state in which the electronic device is connected to a cellular network through the first cellular communication in a call connection status through voice over (Vo) wireless fidelity (Wi-Fi), a first condition related to disconnection of the first cellular communication, and transmit, to the communication processor, in a state in which the electronic device satisfies the first condition related to the disconnection of the first cellular communication, on the basis that the electronic device satisfies a second condition related to the disconnection of the first cellular communication, a signal indicating that the electronic device satisfies the second condition related to the disconnection of the first cellular communication, wherein instructions, when executed by the communication processor, cause the electronic device to prepare to disconnect the first cellular communication and connect the second cellular communication on the basis of reception of the signal indicating that the first condition related to the disconnection of the first cellular communication is satisfied, and perform the disconnection of the first cellular communication and the connection of the second cellular communication based on reception of the signal indicating that the second condition related to the disconnection of the first cellular communication is satisfied.

### CROSS-REFERENCE TO RELATED APPLICATION(S)

This application is a continuation application, claiming priority under 35 U.S.C. § 365(c), of an International application No. PCT/KR2023/014981, filed on Sep. 27, 2023, which is based on and claims the benefit of a Korean patent application number 10-2022-0169764, filed on Dec. 7, 2022, in the Korean Intellectual Property Office, and of a Korean patent application number 10-2023-0000118, filed on Jan. 2, 2023, in the Korean Intellectual Property Office, the disclosure of each of which is incorporated by reference herein in its entirety.

### BACKGROUND

### 1. Field

The disclosure relates to an electronic device and an operation method for an electronic device. More particularly, the disclosure relates to an electronic device that switches a connected cellular communication based on a state of the electronic device.

### 2. Description of Related Art

In order to meet the growing demand for wireless data traffic since the fourth generation (4G) communication system came to the market, there are ongoing efforts to develop enhanced fifth generation (5G) communication systems or pre-5G communication systems. For this reason, the 5G communication system or pre-5G communication system is called the beyond 4G network communication system or post long-term evolution (LTE) system. In order to achieve a high data transmission rate, the 5G communication system is also being considered for implementation in an ultra-high frequency (millimeter wave (mmWave)) band (for example, a band above 6 GHz) in addition to a band (band below 6 GHz) used by LTE. In the 5G communication system, beamforming, massive multiple-input and multiple-out-put (MIMO), and full dimensional MIMO (FD-MIMO), an array antenna, analog beam-forming, and large-scale antenna technologies are being discussed.

As for the frequency bands supported by 5th generation cellular communication, higher frequency bands compared to existing communication schemes may also be used. When the electronic device uses a frequency band communication scheme supported by the 5th generation cellular communication, a data transmission speed may be faster than using the existing communication method.

Access traffic steering, switching, splitting (ATSSS) refers to a technology that manages traffic transmitted through third-generation partnership project (3GPP) networks (e.g., new radio (NR) and LTE) and non-3GPP networks (e.g., wireless Fidelity (Wi-Fi)). Access traffic steering refers to a technology that selects one network among GPP networks (e.g., NR and LTE) and non-3GPP networks (e.g., Wi-Fi) and transmits data through the selected network. Access traffic switching refers to a technology that transmits data to another network while transmitting data to one network. Access traffic splitting refers to a technology that distributes and transmits a single data flow using multiple networks.

The above information is presented as background information only to assist with an understanding of the disclosure. No determination has been made, and no assertion is made, as to whether any of the above might be applicable as prior art with regard to the disclosure.

### SUMMARY

When a voice service request is made via WI-FI when using a 5th generation cellular communication scheme that does not support voice service, the electronic device may switch from 5th generation cellular communication to 4th generation cellular communication that supports voice service.

However, since the electronic device should switch back to the 5th generation cellular communication after the voice service is terminated, the number of signal exchanges due to network movement increases and a data speed may decrease. In addition, the electronic device may have difficulties in supporting network aggregation between Wi-Fi and 5th generation cellular communication under access traffic steering, switching, splitting (ATSSS) that is being developed by the 3GPP. The network aggregation refers to a technology that increases a signal transmission speed by combining multiple networks into one.

Aspects of the disclosure are to address at least the above-mentioned problems and/or disadvantages and to provide at least the advantages described below. Accordingly, an aspect of the disclosure is to provide an electronic device for switching cellular communication on bases of state of electronic device, and operation method for electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a first communication circuit that supports at least one of first cellular communication or second cellular communication, a second communication circuit that supports short-range wireless communication, memory, comprising one or more storage media, storing instructions, an application processor coupled to the memory, and a communication processor coupled to the memory, wherein the instructions, when executed by the application processor, cause the electronic device to check whether the electronic device satisfies a first condition related to a disconnection of the first cellular communication, in a state in which the electronic device is connected to a cellular network through the first cellular communication, in a call connection status through voice over (Vo) wireless fidelity (Wi-Fi), transmit, to the communication processor, a signal indicating that the electronic device satisfies the first condition related to the disconnection of the first cellular communication based on that the electronic device satisfies the first condition related to the disconnection of the first cellular communication, check whether the electronic device satisfies a second condition related to the disconnection of the first cellular communication, in the state where the electronic device satisfies the first condition related to the disconnection of the first cellular communication, and transmit, to the communication processor, a signal indicating that the electronic device satisfies the second condition related to the disconnection of the first cellular communication based on that the electronic device satisfies the second condition related to the disconnection of the first cellular communication, wherein the instructions, when executed by the communication processor, cause the electronic device to prepare to disconnect the first cellular communication and connect the second cellular communication based on reception of the signal indicating that the first condition related to the disconnection of the first cellular communication is satisfied, and disconnect the first cellular communication and connect the second cellular communication based on reception of a signal indicating that the second condition related to the disconnection of the first cellular communication is satisfied.

In accordance with an aspect of the disclosure, an electronic device is provided. The electronic device includes a first communication circuit that supports at least one of first cellular communication or second cellular communication, a second communication circuit that supports short-range wireless communication, memory, comprising one or more storage media, storing instructions, an application processor coupled to the memory, and a communication processor coupled to the memory, wherein instructions, when executed by the application processor, cause the electronic device to check whether the electronic device supports access traffic steering, switching, splitting (ATSSS), in a call connection status through voice over (Vo) wireless fidelity (Wi-Fi), determine whether a base station supporting the first cellular communication exists within a preset distance from the electronic device based on that the electronic device supports the ATSSS, determine whether a signal strength of the Vo Wi-Fi is greater than or equal to a pre-specified level based on that the base station supporting the first cellular communication exists within the preset distance from the electronic device, and transmit, to the communication processor, a signal related to a disconnection of the second cellular communication based on that the signal strength of the Vo Wi-Fi is greater than or equal to the pre-specified level, and wherein instructions, when executed by the communication processor, cause the electronic device to perform the disconnection of the second cellular communication and a connection of the first cellular communication based on a signal related to the disconnection of the second cellular communication received from the application processor.

In accordance with another aspect of the disclosure, a method performed by an electronic device for switching an operation mode of cellular communication is provided. The method includes checking whether a first condition related to a disconnection of a first cellular communication is satisfied in a call connection status through voice over (Vo) wireless fidelity (Wi-Fi), transmitting, to a communication processor, a signal indicating that the electronic device satisfies the first condition related to the disconnection of the first cellular communication based on that the electronic device satisfies the first condition related to the disconnection of the first cellular communication, checking whether the electronic device satisfies a second condition related to the disconnection of the first cellular communication, in a state where the electronic device satisfies the first condition related to the disconnection of the first cellular communication, transmitting, to the communication processor, a signal indicating that the electronic device satisfies the second condition related to the disconnection of the first cellular communication based on that the electronic device satisfies the second condition related to the disconnection of the first cellular communication, preparing to disconnect the first cellular communication and connect the second cellular communication based on reception of a signal indicating that the first condition related to the disconnection of the first cellular communication is satisfied, and disconnecting the first cellular communication and connecting the second cellular communication based on reception of a signal indicating that the second condition related to the disconnection of the first cellular communication is satisfied.

According to an embodiment, the electronic device may increase the data transmission speed by selecting the optimal technology between the 5th generation cellular communication and the 4th generation cellular communication.

According to an embodiment, the electronic device can improve the data performance by supporting the traffic management technology of the access traffic steering, switching, splitting (ATSSS) even when the 5th generation cellular communication does not support the voice over new radio (VoNR) voice service.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram of an electronic device for supporting legacy network communication and 5G network communication according to an embodiment of the disclosure;

FIG. 3 is a diagram illustrating a protocol stack structure of a network of the legacy communication and/or the 5G communication according to an embodiment of the disclosure;

FIGS. 4A, 4B, and 4C are diagrams illustrating wireless communication systems providing a network of the legacy communication and/or the 5G communication according to various embodiments of the disclosure;

FIG. 5 is a diagram illustrating an electronic device and a cellular network according to an embodiment of the disclosure;

FIG. 6 is a block diagram of the electronic device according to an embodiment of the disclosure;

FIG. 7 is a flowchart illustrating an operation method for an electronic device according to an embodiment of the disclosure;

FIG. 8 is a diagram illustrating an embodiment in which the electronic device changes from a connection combination of Wi-Fi and a first cellular communication to a connection combination of Wi-Fi and a second cellular communication according to an embodiment of the disclosure; and

FIG. 9 is a diagram illustrating an embodiment in which the electronic device changes from the connection combination of the Wi-Fi and the second cellular communication to the connection combination of the Wi-Fi and the first cellular communication according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

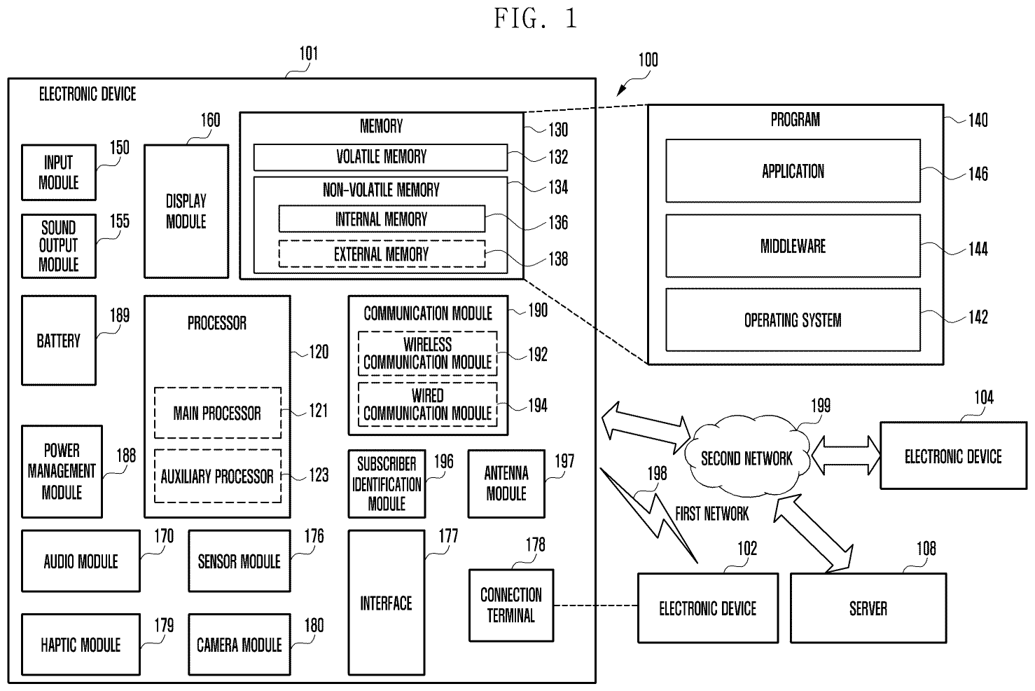

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

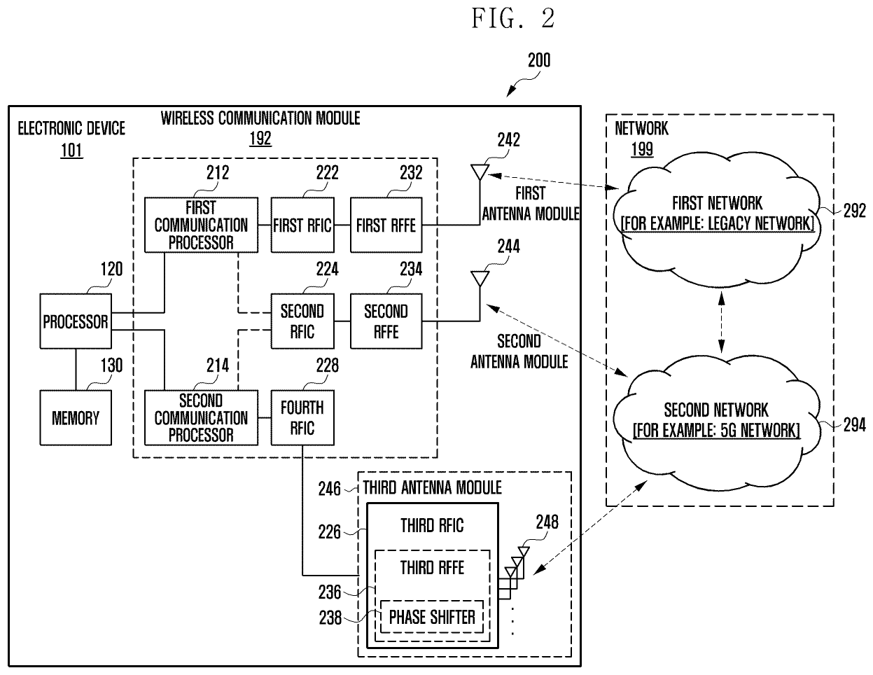

FIG. 2 is a block diagram 200 of the electronic device 101 for supporting legacy network communication and 5G network communication according to an embodiment of the disclosure.

Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The network 199 may include a first network 292 and a second network 294. According to another embodiment, the electronic device 101 may further include at least one of the components described in FIG. 1, and the network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of the wireless communication module 192. According to another embodiment, the fourth RFIC 228 may be omitted or included as part of the third RFIC 226.

The first communication processor 212 may support establishment of a communication channel in a band to be used for wireless communication with the first network 292, and legacy network communication through the established communication channel. According to various embodiments, the first network may be a legacy network including a second generation (2G), third generation (3G), 4G, or long-term evolution (LTE) network. The second communication processor 214 may support establishment of a communication channel corresponding to a specified band (e.g., about 6 GHz to about 60 GHz) among the bands to be used for the wireless communication with the second network 294, and 5G network communication through the established communication channel. According to various embodiments, the second network 294 may be the 5G network defined by 3GPP. Additionally, according to an embodiment, the first communication processor 212 or the second communication processor 214 may support establishment of communication channel corresponding to another specified band (e.g., about 6 GHz or less) among the bands to be used for the wireless communication with the second network 294, and the 5G network communication through the established communication channel. According to an embodiment, the first communication processor 212 and the second communication processor 214 may be implemented in a single chip or a single package. According to various embodiments, the first communication processor 212 or the second communication processor 214 may be formed within the single chip or the single package with the processor 120, the auxiliary processor 123, or the communication module 190.

Upon transmission, the first RFIC 222 may convert a baseband signal generated by the first communication processor 212 into a radio frequency (RF) signal of about 700 MHz to about 3 GHz used in the first network 292 (e.g., a legacy network). Upon reception, the RF signal may be acquired from the first network 292 (e.g., the legacy network) via an antenna (e.g., the first antenna module 242) and preprocessed via an RFFE (e.g., the first RFFE 232). The first RFIC 222 may convert the preprocessed RF signal into the baseband signal so that the preprocessed RF signal may be processed by the first communication processor 212.

Upon transmission, the second RFIC 224 may convert the baseband signal generated by the first communication processor 212 or the second communication processor 214 into the RF signal (hereinafter, a 5G Sub6 RF signal) of a Sub6 band (e.g., about 6 GHz or less) used in the second network 294 (e.g., the 5G network). Upon reception, the 5G Sub6 RF signal may be acquired from the second network 294 (e.g., the 5G network) via the antenna (e.g., the second antenna module 244) and preprocessed through the RFFE (e.g., the second RFFE 234). The second RFIC 224 may convert the preprocessed 5G Sub6 RF signal into the baseband signal so that the preprocessed 5G Sub6 RF signal may be processed by the corresponding communication processor of the first communication processor 212 or the second communication processor 214.

The third RFIC 226 may convert the baseband signal generated by the second communication processor 214 into an RF signal (hereinafter, a 5G Above6 RF signal) of a 5G Above6 band (e.g., about 6 GHz to about 60 GHz) to be used in the second network 294 (e.g., the 5G network). Upon reception, the 5G Above6 RF signal may be acquired from the second network 294 (e.g., the 5G network) via the antenna (e.g., antenna 248) and preprocessed through the third RFFE 236. The third RFIC 226 may convert the preprocessed 5G Above6 RF signal into the baseband signal so that the preprocessed 5G Above6 RF signal may be processed by the second communication processor 214. According to an embodiment, the third RFFE 236 may be formed as a part of the third RFIC 226.

According to an embodiment, the electronic device 101 may include the fourth RFIC 228 separately from or at least as a part of the third RFIC 226. In this case, the fourth RFIC 228 may convert the baseband signal generated by the second communication processor 214 into an RF signal (hereinafter, referred to as an IF signal) of an intermediate frequency band (e.g., about 9 GHz to about 11 GHz) and then transmit the IF signal to the third RFIC 226. The third RFIC 226 may convert the IF signal into the 5G Above6 RF signal. Upon reception, the 5G Above6 RF signal may be received from the second network 294 (e.g., the 5G network) via the antenna (e.g., antenna 248) and converted into the IF signal by the third RFIC 226. The fourth RFIC 228 may convert the IF signal into the baseband signal for processing by the second communication processor 214.

According to an embodiment, the first RFIC 222 and the second RFIC 224 may be implemented as at least part of a single chip or a single package. According to an embodiment, the first RFFE 232 and the second RFFE 234 may be implemented as at least part of a single chip or a single package. According to an embodiment, at least one antenna module of the first antenna module 242 or the second antenna module 244 may be omitted or combined with another antenna module to process RF signals of multiple corresponding bands.

According to an embodiment, the third RFIC 226 and the antenna 248 may be arranged on the same substrate to form the third antenna module 246. For example, the wireless communication module 192 or the processor 120 may be arranged on a first substrate (e.g., main PCB). In this case, the third RFIC 226 may be arranged on a partial area (e.g., bottom) of a second substrate (e.g., sub PCB) separate from the first substrate, and the antenna 248 may be arranged on another partial area (e.g., top) to form the third antenna module 246. By arranging the third RFIC 226 and the antenna 248 on the same substrate, it is possible to reduce a length of a transmission line therebetween. This may reduce, for example, a loss (e.g., attenuation) of a signal in a high-frequency band (e.g., about 6 GHz to about 60 GHz) used for the 5G network communication by the transmission line. As a result, the electronic device 101 may improve the quality or speed of communication with the second network 294 (e.g., the 5G network).

According to an embodiment, the antenna 248 may be formed as an antenna array including a plurality of antenna elements that may be used for beamforming. In such a case, the third RFIC 226 may include a plurality of phase shifters 238 corresponding to the plurality of antenna elements, for example, as part of the third RFFE 236. Upon transmission, each of the plurality of phase shifters 238 may shift a phase of the 5G Above6 RF signal to be transmitted to an outside (e.g., a base station of the 5G network) of the electronic device 101 via the corresponding antenna element. Upon reception, each of the plurality of phase shifters 238 may shift the phase of the 5G Above6 RF signal received from the outside via the corresponding antenna element to the same phase or substantially the same phase. This enables transmission or reception via the beamforming between the electronic device 101 and the outside.

The second network 294 (e.g., the 5G network) may operate independently (e.g., stand-alone (SA)) or connected (e.g., non-standalone (NSA)) from the first network 292 (e.g., the legacy network). For example, the 5G network may only have an access network (e.g., a 5G radio access network (RAN) or a next generation RAN (NG RAN)) and have no core network (e.g., a next generation core (NGC)). In such a case, the electronic device 101 may access an external network (e.g., the Internet) under the control of the core network (e.g., an evolved packed core (EPC)) of the legacy network after accessing the access network of the 5G network. Protocol information (e.g., LTE protocol information) for communicating with the legacy network or protocol information (e.g., new radio (NR) protocol information) for communicating with the 5G network may be stored in the memory 130 and accessed by other components (e.g., the processor 120, the first communication processor 212, or the second communication processor 214).

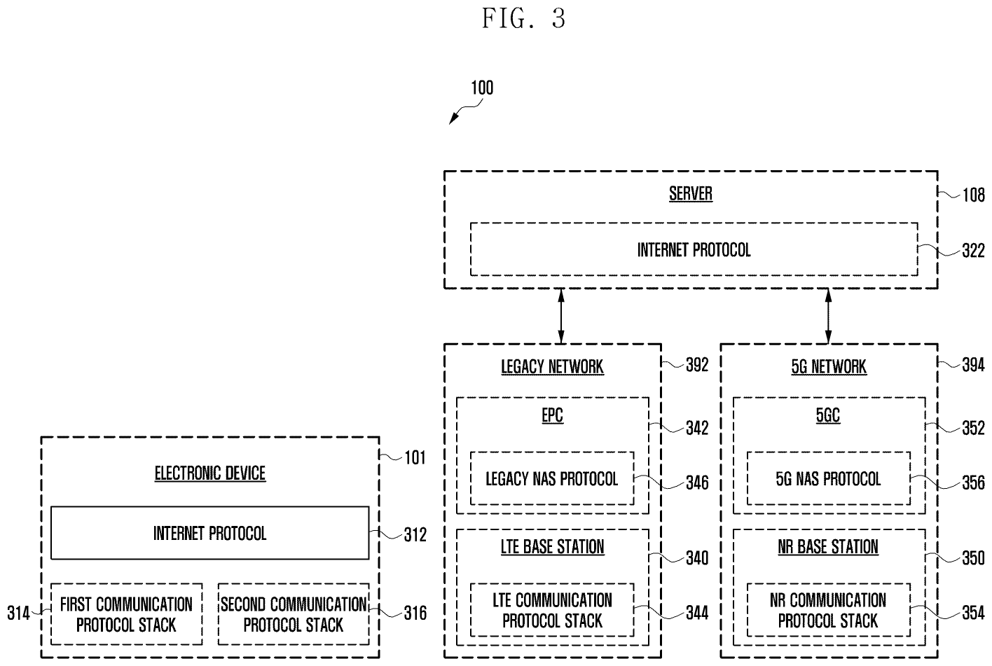

FIG. 3 is a diagram illustrating a protocol stack structure of the network 100 of the legacy communication and/or the 5G communication according to an embodiment of the disclosure.

Referring to FIG. 3, the network 100 according to the illustrated embodiment may include the electronic device 101, a legacy network 392, a 5G network 394, and the server 108.

The electronic device 101 may include an Internet protocol 312, a first communication protocol stack 314, and a second communication protocol stack 316. The electronic device 101 may communicate with the server 108 via the legacy network 392 and/or the 5G network 394.

According to an embodiment, the electronic device 101 may perform Internet communication associated with the server 108 using the Internet protocol 312 (e.g., TCP, UDP, and IP). The Internet protocol 312 may be executed, for example, in a main processor (e.g., the main processor 121 of FIG. 1) included in the electronic device 101.

In another embodiment, the electronic device 101 may wirelessly communicate with the legacy network 392 using the first communication protocol stack 314. According to another embodiment, the electronic device 101 may wirelessly communicate with the 5G network 394 using the second communication protocol stack 316. The first communication protocol stack 314 and the second communication protocol stack 316 may be executed, for example, in one or more communication processors (e.g., the wireless communication module 192 of FIG. 1) included in the electronic device 101.

The server 108 may include an Internet protocol 322. The server 108 may transmit and receive data related to the electronic device 101 and the Internet protocol 322 via the legacy network 392 and/or the 5G network 394. According to an embodiment, the server 108 may include a cloud computing server that exists outside the legacy network 392 or the 5G network 394. In another embodiment, the server 108 may include an edge computing server (or, a mobile edge computing (MEC) server) located inside at least one of the legacy network or the 5G network 394.

The legacy network 392 may include an LTE base station 340 and an EPC 342. The LTE base station 340 may include an LTE communication protocol stack 344. The EPC 342 may include a legacy NAS protocol 346. The legacy network 392 may perform LTE wireless communication with the electronic device 101 using the LTE communication protocol stack 344 and the legacy NAS protocol 346.

The 5G network 394 may include an NR base station 350 and a 5GC 352. The NR base station 350 may include an NR communication protocol stack 354. The 5GC 352 may include a 5G NAS protocol 356. The 5G network 394 may perform NR wireless communication with the electronic device 101 using the NR communication protocol stack 354 and the 5G NAS protocol 356.

According to an embodiment, the first communication protocol stack 314, the second communication protocol stack 316, the LTE communication protocol stack 344, and the NR communication protocol stack 354 may include a control plane protocol for transmitting and receiving a control message and a user plane protocol for transmitting and receiving user data. The control message may include, for example, a message related to at least one of security control, bearer setup, authentication, registration, or mobility management. The user data may include, for example, the remaining data except for the control message.

According to an embodiment, a control plane protocol and a user plane protocol may include physical (PHY), medium access control (MAC), radio link control (RLC), or packet data convergence protocol (PDCP) layers. The PHY layer may, for example, channel code and modulate data received from a higher layer (e.g., the MAC layer) and transmit the channel-coded and modulated data through a wireless channel, and demodulate and decode data received through the wireless channel and deliver the demodulated and decode data to the higher layer. The PHY layer included in the second communication protocol stack 316 and the NR communication protocol stack 354 may further perform operations related to the beamforming. The MAC layer may be logically/physically mapped, for example, to the wireless channel through which data is to be transmitted and received, and perform hybrid automatic repeat request (HARQ) for error correction. The RLC layer may perform, for example, concatenation, segmentation, or reassembly of data, and perform data ordering, reordering, or duplication checking of data. The PDCP layer may perform, for example, operations related to ciphering and data integrity of the control message and the user data. The second communication protocol stack 316 and the NR communication protocol stack 354 may further include a service data adaptation protocol (SDAP). The SDAP may, for example, manage radio bearer allocation based on quality of service (QoS) of user data.

According to various embodiments, the control plane protocol may include a radio resource control (RRC) layer and a non-access stratum (NAS) layer. The RRC layer may, for example, process control data related to radio bearer setup, paging, or mobility management. The NAS may, for example, process control messages related to authentication, registration, and mobility management.

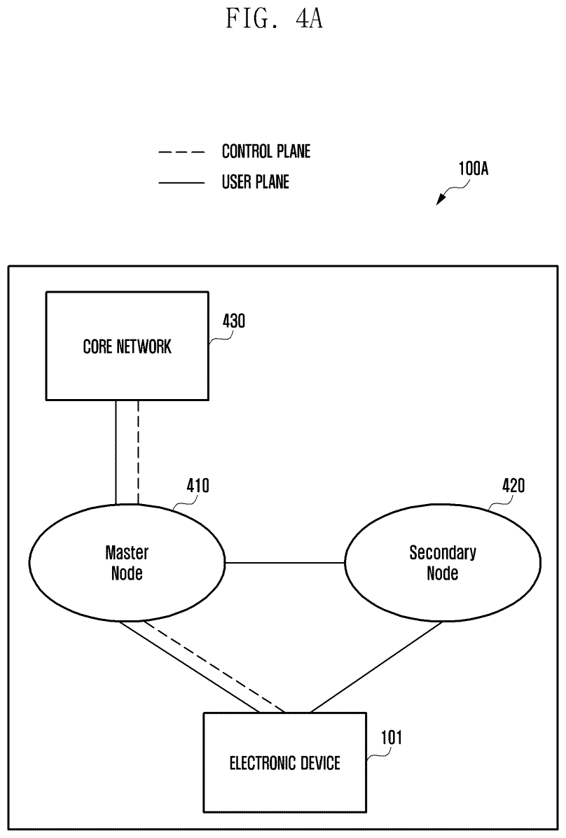

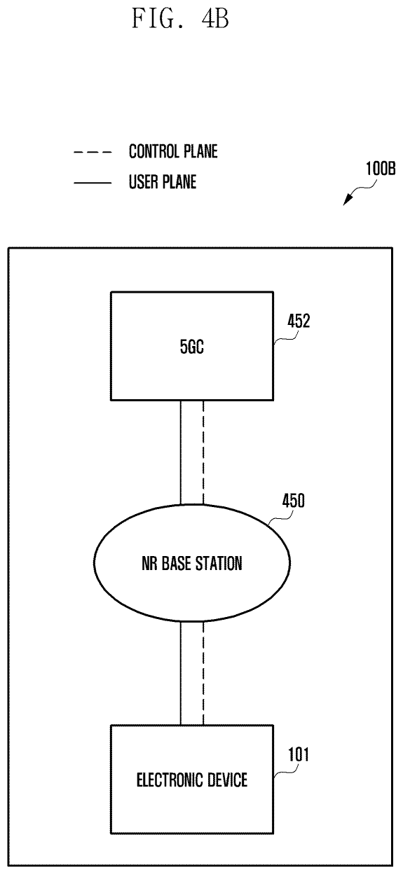

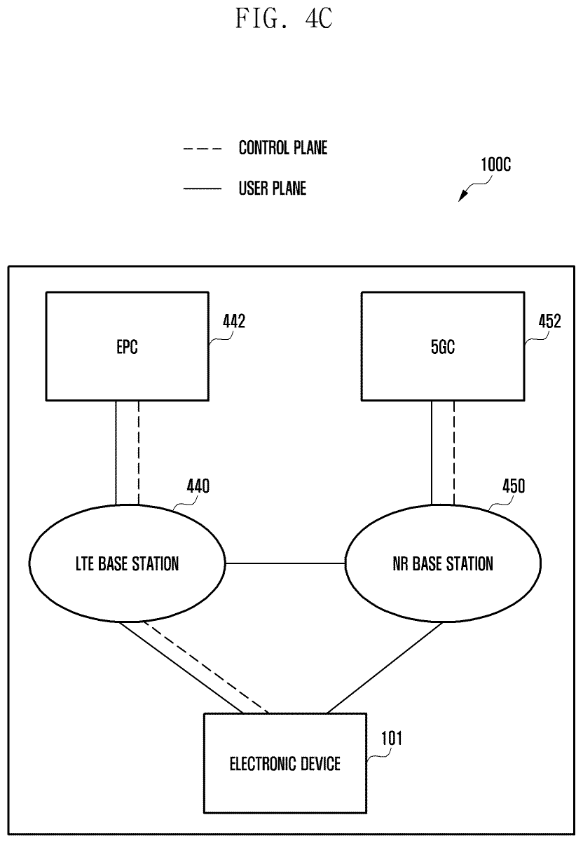

FIGS. 4A, 4B, and 4C are diagrams illustrating wireless communication systems providing a network of the legacy communication and/or the 5G communication according to various embodiments of the disclosure.

Referring to FIGS. 4A, 4B, and 4C, a network environment 100A to 100C may include at least one of the legacy network and the 5G network. The legacy network may include, for example, a 4G or LTE base station 440 (e.g., an eNodeB (eNB)) of the 3GPP standard that supports the wireless connection with the electronic device 101 and an evolved packet core (EPC) 451 that manages the 4G communication. The 5G network may include, for example, a new radio (NR) base station 450 (e.g., a gNodeB (gNB)) that supports radio access with the electronic device 101 and a 5th generation core (5GC) 452 that manages the 5G communication of the electronic device 101.

According to various embodiments, the electronic device 101 may transmit and receive the control messages and the user data via the legacy communication and/or the 5G communication. The control message may include, for example, a message related to at least one of security control, bearer setup, authentication, registration, or mobility management of the electronic device 101. The user data may mean, for example, user data excluding the control message transmitted and received between the electronic device 101 and the core network 430 (e.g., EPC 442).

Referring to FIG. 4A, the electronic device 101 according to an embodiment may transmit and receive at least one of the control message or the user data to and from at least part of the 5G network (e.g., the NR base station 450 and the 5GC 452) using at least part of the legacy network (e.g., the LTE base station 440 and the EPC 442).

According to various embodiments, the network environment 100A may include a network environment that provides wireless communication dual connectivity (multi-radio access technology (multi-RAT) dual connectivity (MR-DC)) to the LTE base station 440 and the NR base station 450, and transmits and receives the control message to and from the electronic device 101 through the core network 430 of one of the EPC 442 or the 5GC 452.

According to various embodiments, in the MR-DC environment, one of the LTE base station 440 or the NR base station 450 may operate as a master node (MN) 410 and the other may operate as a secondary node (SN) 420. The MN 410 may be connected to the core network 430 to transmit and receive the control message. The MN 410 and the SN 420 may be connected through a network interface to transmit and receive messages related to management of radio resources (e.g., communication channels) to and from each other.

According to various embodiments, the MN 410 may be composed of the LTE base station 440, the SN 420 may be composed of the NR base station 450, and the core network 430 may be composed of the EPC 442. For example, the control message may be transmitted and received through the LTE base station 440 and the EPC 442, and the user data may be transmitted and received through the LTE base station 440 and the NR base station 450.

Referring to FIG. 4B, according to various embodiments, the 5G network may independently transmit and receive the control message and the user data to and from the electronic device 101.

Referring to FIG. 4C, according to various embodiments, the legacy network and the 5G network may independently transmit and receive data. For example, the electronic device 101 and the EPC 442 may transmit and receive the control message and the user data through the LTE base station 440. For another example, the electronic device 101 and the 5GC 452 may transmit and receive the control message and the user data through the NR base station 450.

According to various embodiments, the electronic device 101 may be registered with at least one of the EPC 442 or the 5GC 452 to transmit and receive the control message.

According to various embodiments, the EPC 442 or the 5GC 452 may interwork to manage the communication of the electronic device 101. For example, the movement information of the electronic device 101 may be transmitted and received through an interface between the EPC 442 and the 5GC 452.

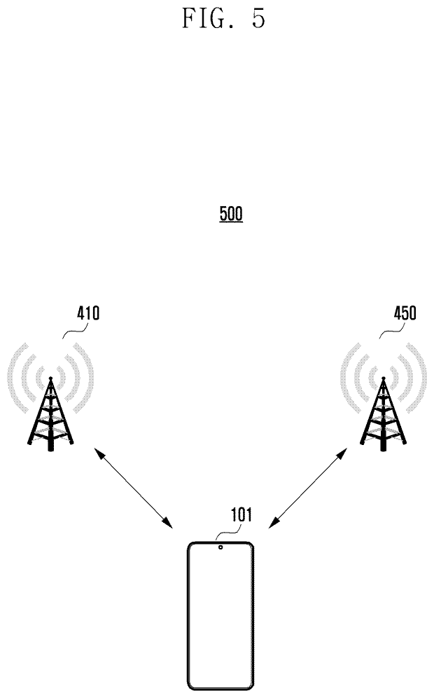

FIG. 5 is a diagram illustrating an electronic device and a cellular network according to an embodiment of the disclosure.

According to various embodiments of the disclosure, a cellular network 500 may include a first node (e.g., the NR base station 450 of FIG. 4B) and/or a second node (e.g., the master node 410 of FIG. 4A).

According to various embodiments of the disclosure, the first node 450 may be a base station supporting first cellular communication. The first cellular communication may refer to any one of various cellular communication schemes that the electronic device 101 can support, for example, a communication scheme on the second network 294 of FIG. 2. For example, the first cellular communication may be a communication scheme that uses a 5th generation mobile communication scheme (e.g., new radio). According to an embodiment, the first node 450 may be a base station that supports a standalone mode supported by the first cellular communication. The standalone mode may be a mode in which the electronic device 101 transmits or receives data using a base station that supports the first cellular communication. The electronic device 101 may be connected to the first node 450 to transmit or receive data. Alternatively, the first node 450 may be a base station that supports a non-standalone mode supported by the first cellular communication. The non-standalone mode may be a mode in which the electronic device 101 transmits or receives the data using the base station supporting the first cellular communication and the base station supporting the second cellular communication. The electronic device 101 may be connected to the first node 450 and/or the second node 460 to transmit or receive the data.

According to various embodiments of the disclosure, the second node 410 may be the base station supporting the second cellular communication. The second cellular communication may refer to any one of various cellular communication schemes that the electronic device (e.g., the electronic device 101 of FIG. 1) can support, for example, a communication scheme on the first network 292 of FIG. 2. For example, the second cellular communication may be a communication scheme that uses a 4th generation mobile communication scheme (e.g., long term evolution).

According to various embodiments of the disclosure, the first cellular communication may be a cellular communication that performs data communication using a relatively high frequency band compared to the second cellular communication. A frequency band of the first cellular communication may have a higher frequency band compared to that of the second cellular communication. The first node 450 supporting the first cellular communication may implement a relatively high speed compared to the second node 410 supporting the second cellular communication due to the characteristics of the high frequency band.

The electronic device 101 may perform a fallback to support a voice service when performing voice over wi-fi (VoWi-Fi) to establish a communication connection with the second node 410 supporting the second cellular communication. When the voice service is terminated, the electronic device 101 may establish a communication connection again with the first node 450 supporting the first cellular communication. The electronic device 101 may perform the fallback regardless of a service state of the first cellular communication, thereby increasing signaling and decrease a data speed.

Hereinafter, in order to alleviate (or resolve) the phenomenon, an embodiment is described in which an electronic device 101 performs a fallback based on the service state (e.g., load balancing ratio) of the first cellular communication, depending on conditions. Even if the first cellular communication does not support the VoNR, the electronic device 101 may maintain the connection with the first cellular communication to prevent the signaling from unnecessarily increasing and quickly control the data speed when the voice service of the lower 3GPP network (e.g., the second cellular communication) is not in use.

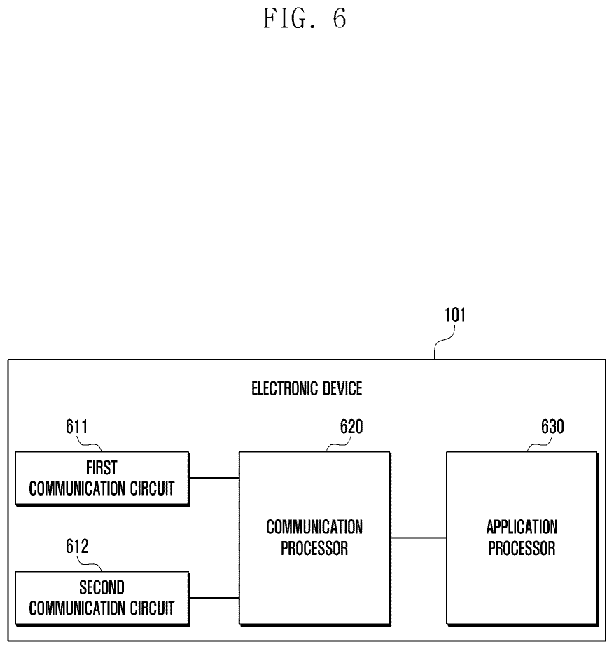

FIG. 6 is a diagram illustrating the electronic device according to an embodiment of the disclosure.

Referring to FIG. 6, an electronic device (e.g., the electronic device 101 of FIG. 1) may include a first communication circuit 611, a second communication circuit 612, a communication processor (e.g., the first communication processor 212 of FIG. 2 and/or the second communication processor 214 of FIG. 2) 620, and/or an application processor (e.g., the processor 120 of FIG. 1) 630.

The application processor 630 may control various components of the electronic device 101. Specific operations will be described later.

The communication processor 620 may perform data transmission and/or reception via the first cellular communication and/or the second cellular communication. The communication processor 640 may be connected to a first node (e.g., the first node 450 of FIG. 4B) via the first cellular communication, or connected to a second node (e.g., the second node 410 of FIG. 4A) via the second cellular communication. The communication processor 620 may transmit user data received from the application processor 630 via the first cellular communication and/or the second cellular communication, and transmit user data received via the first cellular communication and/or the second cellular communication to the application processor 630.

The first cellular communication may refer to any one of various cellular communication schemes that the electronic device 101 can support, for example, a communication scheme on the second network 294 of FIG. 2. For example, the first cellular communication may be a communication scheme that uses a 5th generation mobile communication scheme (e.g., new radio).

The second cellular communication may refer to any one of various cellular communication schemes that the electronic device (e.g., the electronic device 101 of FIG. 1) can support, for example, the communication scheme on the first network 292 of FIG. 2. For example, the second cellular communication may be a communication scheme that uses a 4th generation mobile communication scheme (e.g., long term evolution).

The first communication circuit 611 is a communication circuit that supports the first cellular communication and/or the second cellular communication, and may provide communication with an external electronic device (e.g., the external electronic device 104 of FIG. 1) to the electronic device 101 through the first cellular communication and/or the second cellular communication.

The second communication circuit 612 is a communication circuit that supports short-range wireless communication (e.g., Wi-Fi), and may provide the communication with the external electronic device (e.g., the external electronic device 104 of FIG. 1) to the electronic device 101 through the short-range wireless communication (e.g., Wi-Fi).

The electronic device 101 may perform the disconnection of the first cellular communication and the connection of the second cellular communication in order to provide the voice service, while being in the connected state of the first cellular communication. Hereinafter, a specific embodiment of the disconnection of the first cellular communication will be described.

The application processor 630 may check whether the electronic device 101 satisfies the conditions related to the disconnection of the first cellular communication while being in the connected state through the first cellular communication.

The conditions related to the disconnection of the first cellular communication may include conditions in which the load balancing rate of the Wi-Fi is relatively higher than the load balancing rate of the NR. The load balancing refers to an operation of balancing a load being processed by using one communication scheme (e.g., NR or LTE) into multiple communication schemes (Wi-Fi+NR or Wi-Fi+LTE).

The conditions related to the disconnection of the first cellular communication may include a case in which an active standby mode corresponds to the Wi-Fi. The active standby mode refers to a mode in which one communication scheme operates in an active state and the remaining communication schemes operate in a standby state.

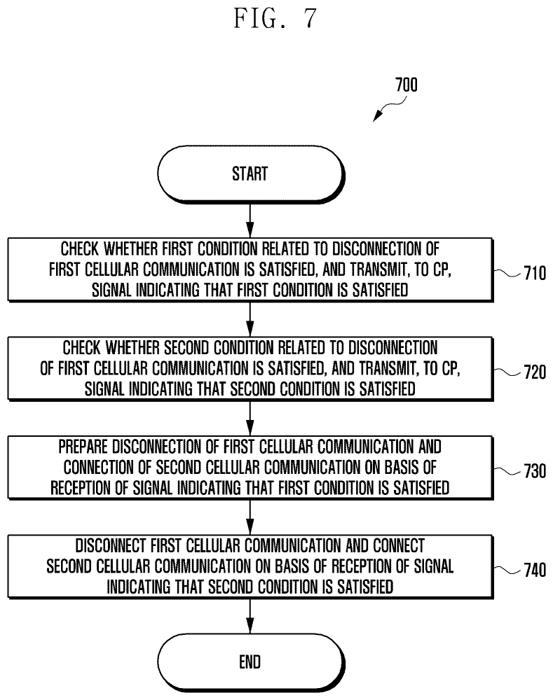

The conditions related to the disconnection of the first cellular communication may include a case where the priority of the communication scheme for performing the data transmission/reception is higher for the Wi-Fi than for the cellular network (LTE and NR). Since the Wi-Fi is preferentially used for the data transmission in the case where the priority of the communication scheme for performing the data transmission/reception is higher for the Wi-Fi than for the cellular network (LTE and NR), the amount of data transmission using the NR is relatively small, so the need to use the Wi-Fi and the NR together using the ATSSS technology may be reduced. Therefore, the electronic device 101 may prepare the fallback to the LTE that may support the voice service instead of maintaining the use of the NR. This will be described with reference to FIG. 7.

FIG. 7 is a flowchart illustrating an operation method for an electronic device according to an embodiment of the disclosure.

The operations described with reference to FIG. 7 may be implemented based on instructions that may be stored in the computer recording medium or the memory (e.g., the memory 130 of FIG. 1). An illustrated method 700 may be executed by the electronic device (e.g., the electronic device 101 of FIG. 6) described with reference to FIGS. 1 to 3, 4A to 4C, 5, and 6 above, and the technical features described above will be omitted below. The order of each operation of FIG. 7 may be changed, some operations may be omitted, and some operations may be performed simultaneously.

In operation 710, the application processor (e.g., the application processor 630 of FIG. 6) may check whether a first condition related to the disconnection of the first cellular communication is satisfied, and transmit a signal indicating that the first condition is satisfied to the communication processor (e.g., the communication processor 620 of FIG. 6).

According to an embodiment, the first cellular communication may include new radio (NR). The second cellular communication may include long-term evolution (LTE). According to an embodiment, a first condition related to the disconnection of the first cellular communication may include a condition in which the load balancing rate of the Wi-Fi is relatively higher than the load balancing rate of the NR. The load balancing refers to an operation of balancing a load being processed by using one communication scheme (e.g., the NR or LTE) into multiple communication schemes (Wi-Fi+NR or Wi-Fi+LTE). When the load balancing rate of the Wi-Fi is relatively higher than the load balancing rate of the NR, the electronic device may determine that a signal transmission ratio using the Wi-Fi is relatively higher. In this case, since the amount of data transmission using the NR is relatively small, the need to use the Wi-Fi and the NR together using the access traffic steering, switching, splitting (ATSSS) technology may be reduced. Therefore, the electronic device 101 may prepare the fallback to the LTE that may support the voice service instead of maintaining the use of the NR. The ATSSS refers to a technology that manages traffic transmitted through the 3GPP networks (e.g., the NR and LTE) and the non-3GPP networks (e.g., the Wi-Fi). The access traffic steering refers to a technology that selects one network among the GPP networks (e.g., the NR and LTE) and the non-3GPP networks (e.g., the Wi-Fi) and transmits data through the selected network. The access traffic switching refers to a technology that transmits data to another network while transmitting data to one network. The access traffic splitting refers to a technology that distributes and transmits a single data flow using multiple networks. The application processor 630 may transmit, to the communication processor 620, a signal indicating that the first condition is satisfied based on that the load balancing rate of the Wi-Fi is relatively higher than the load balancing rate of the NR.

According to an embodiment, the first condition related to the disconnection of the first cellular communication may include a case where the active standby mode corresponds to the Wi-Fi. The active standby mode refers to a mode in which one communication scheme operates in an active state and the remaining communication schemes operate in a standby state. The electronic device may control to execute a service on a server with a highest score or priority among the standby servers when a failure occurs in the active server. When the active standby mode corresponds to the Wi-Fi, the electronic device may preferentially transmit data using the Wi-Fi, and since the amount of data transmission using the NR is relatively small, the need to use the Wi-Fi and the NR together using the ATSSS technology may be reduced. Therefore, the electronic device 101 may prepare the fallback to the LTE that may support the voice service instead of maintaining the use of the NR. The application processor 630 may transmit, to the communication processor 620, the signal indicating that the first condition is satisfied based on that the active standby mode corresponds to the Wi-Fi.

The conditions related to the disconnection of the first cellular communication may include a case where the priority of the communication scheme for performing the data transmission/reception is higher for the Wi-Fi than for the cellular network (LTE and NR). Since the Wi-Fi is preferentially used for the data transmission in the case where the priority of the communication scheme for performing the data transmission/reception is higher for the Wi-Fi than for the cellular network (LTE and NR), the amount of data transmission using the NR is relatively small, so the need to use the Wi-Fi and the NR together using the ATSSS technology may be reduced. Therefore, the electronic device 101 may prepare the fallback to the LTE that may support the voice service instead of maintaining the use of the NR. The application processor 630 may transmit, to the communication processor 620, the signal indicating that the first condition is satisfied based on that the priority-based corresponds to the Wi-Fi.

In operation 720, the application processor 630 may check whether a second condition related to the disconnection of the first cellular communication is satisfied, and transmit a signal indicating that the second condition is satisfied to the communication processor 620.

According to an embodiment, the second condition may include a condition in which the load balancing of the first cellular communication is less than (or less than or equal to) a pre-specified level (e.g., about 10%). The first cellular communication may include the new radio (NR). When the load balancing of the NR is less than the specified level, the load balancing of the NR may be lowered because the signal strength of the NR is relatively poor compared to the signal strength of the Wi-Fi, so the electronic device 101 may perform the fallback to the LTE that may support a voice service instead of maintaining the use of the NR. The application processor 630 may transmit, to the communication processor 620, the signal indicating that the second condition related to the disconnection of the first cellular communication is satisfied based on that the load balancing of the first cellular communication is less than (or less than or equal to) the pre-specified level.

In operation 730, the communication processor 620 may prepare to disconnect the first cellular communication and connect the second cellular communication based on the reception of the signal indicating that the first condition is satisfied. The communication processor 620 may prepare to disconnect the communication via the NR, and at the same time, connect the communication with the LTE based on the reception of the signal indicating that the first condition is satisfied.

In operation 740, the communication processor 620 may perform the disconnection of the first cellular communication and the connection of the second cellular communication based on the reception of the signal indicating that the second condition is satisfied.

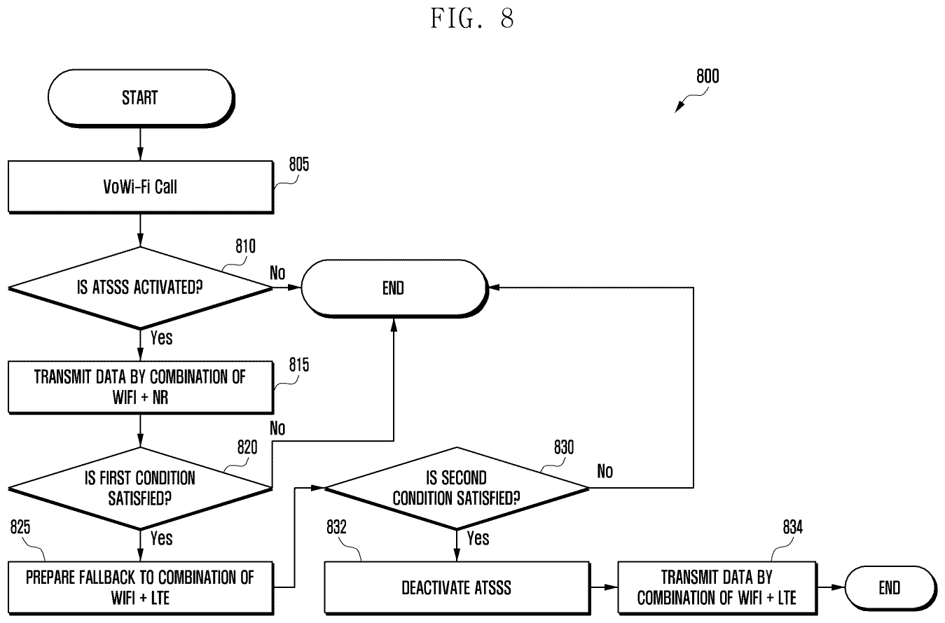

FIG. 8 is a diagram illustrating an embodiment in which the electronic device change from a connection combination of the Wi-Fi and the first cellular communication to a connection combination of the Wi-Fi and the second cellular communication according to an embodiment of the disclosure.

The operations described with reference to FIG. 8 may be implemented based on instructions that may be stored in the computer recording medium or the memory (e.g., the memory 130 of FIG. 1). An illustrated method 800 may be executed by the electronic device (e.g., the electronic device 101 of FIG. 6) described with reference to FIGS. 1 to 3, 4A to 4C, 5, and 6 above, and the technical features described above will be omitted below. The order of each operation of FIG. 8 may be changed, some operations may be omitted, and some operations may be performed simultaneously.

In operation 805, the electronic device 101 may be registered with a 5G network (NW) and may be in a state capable of supporting VoWi-Fi.

In operation 810, the electronic device 101 may determine whether the access traffic steering, switching, splitting (ATSSS) is in an active state. The ATSSS refers to a technology that manages traffic transmitted through the 3GPP networks (e.g., the NR and LTE) and the non-3GPP networks (e.g., the Wi-Fi). The access traffic steering refers to a technology that selects one network among the GPP networks (e.g., the NR and LTE) and the non-3GPP networks (e.g., the Wi-Fi) and transmits data through the selected network. The access traffic switching refers to a technology that transmits data to another network while transmitting data to one network. The access traffic splitting refers to a technology that distributes and transmits a single data flow using multiple networks. The electronic device 101 may determine whether to support the ATSSS through an ATSSS support indicator (ATS-IND) during a network registration process. For example, when the electronic device 101 can support the ATSSS, the ATS-IND may be displayed as 1, and when the electronic device 101 cannot support the ATSSS, the ATS-IND may be displayed as 0. This is not fixed, and the electronic device 101 may display the ATS-IND as 0 to display that the ATSSS support is possible, and the electronic device 101 may display the ATS-IND as 1 to display that the ATSSS support is not possible.

According to an embodiment, the electronic device 101 may check whether a network node supports the ATSSS through a register procedure. When the electronic device 101 is registered with the network that supports the ATSSS, the electronic device 101 may request multi access protocol data unit (MA PDU) session establishment. The multi access (MA) refers to a multiple access technology in which multiple terminals share the same communication channel. A protocol data unit (PDU) refers to a unit of data used in a protocol. The electronic device 101 may request the MA PDU session establishment by establishing a request type to a “MA PDU request” in a UL NAS transport message. The electronic device 101 may establish the MA PDU session between the electronic device 101 and the network through a PDU session establishment request (request type: MA PDU request) and a PDU session establishment accept (ATSSS container IE), and acquire at least one ATSSS parameter. The ATSSS parameter for utilizing resources of the 3GPP and non-3GPP in the 5G core of TS 24.193 may include, for example, one of data traffic, active-standby, load-balancing, and priority-based.

The electronic device 101 may perform routing through the corresponding network (e.g., active network) until one network (e.g., the 5G or Wi-Fi) may not use data traffic. The routing refers to a process of selecting a data transmission path on the network. The electronic device 101 may switch to another network (e.g., standby network) when that the corresponding network may not use the data traffic. The electronic device 101 may switch traffic back to a previously used network (e.g., the active network) when the previously used network becomes available again. The load balancing may refer to a parameter that adjusts the ratio of the data traffic to be transmitted through the 3GPP (e.g., the 5G NW) and the data traffic to be transmitted through the non-3GPP (e.g., the Wi-Fi NW). The priority-based may refer to a parameter that preferentially transmits the data traffic through a network with a specified higher priority. The electronic device 101 may transmit data traffic by switching to a network with a lower priority when a network with a higher priority may not be used.

In operation 815, the electronic device 101 may transmit data using a combination of the Wi-Fi and the new radio (NR) based on that the ATSSS is activated. The Wi-Fi may correspond to the non-3GPP network, and the NR may correspond to the 3GPP network.

In operation 820, the electronic device 101 may determine whether the first condition related to the disconnection of the first cellular communication is satisfied. According to an embodiment, the first cellular communication may include the new radio (NR). The second cellular communication may include the long-term evolution (LTE). The application processor (e.g., the application processor 630 of FIG. 6) may check whether the first condition related to the disconnection of the first cellular communication is satisfied, and transmit the signal indicating that the first condition is satisfied to the communication processor (e.g., the communication processor 620 of FIG. 6).

According to an embodiment, the first condition related to the disconnection of the first cellular communication may include the condition in which the load balancing rate of the Wi-Fi is relatively higher than the load balancing rate of the NR. The load balancing refers to the operation of balancing the load being processed by using one communication scheme (e.g., the NR or LTE) into multiple communication schemes (Wi-Fi+NR or Wi-Fi+LTE). The electronic device 101 may acquire the ATSSS parameter including the load balancing while establishing the MA PDU session between the networks. When the load balancing rate of the Wi-Fi is relatively higher than the load balancing rate of the NR, the electronic device 101 may determine that the signal transmission ratio using the Wi-Fi is relatively higher. In this case, since the amount of data transmission using the NR is relatively small, the need to use the Wi-Fi and the NR together using the access traffic steering, switching, splitting (ATSSS) technology may be reduced. Therefore, the electronic device 101 may prepare the fallback to the LTE that may support the voice service instead of maintaining the use of the NR.

According to an embodiment, the first condition related to the disconnection of the first cellular communication may include the case where the active standby mode corresponds to the Wi-Fi. The active standby mode refers to a mode in which one server operates in an active state and the remaining servers operate in a standby state. The electronic device may control to execute a service on a server with a highest score or priority among the standby servers when the failure occurs in the active server. The electronic device 101 may acquire the ATSSS parameter including the active standby mode while establishing the MA PDU session between the networks. When the active standby mode corresponds to the Wi-Fi, the electronic device may preferentially transmit data using the Wi-Fi, and since the amount of data transmission using the NR is relatively small, the need to use the Wi-Fi and the NR together using the ATSSS technology may be reduced. Therefore, the electronic device 101 may prepare the fallback to the LTE that may support the voice service instead of maintaining the use of the NR. The application processor 630 may transmit, to the communication processor 620, the signal indicating that the first condition is satisfied based on that the active standby mode corresponds to the Wi-Fi.

According to an embodiment, the first condition related to the disconnection of the first cellular communication may include the case where the priority-based corresponds to the Wi-Fi. In the case where the priority-based corresponds to the Wi-Fi, since the Wi-Fi is preferentially used for the data transmission, the amount of data transmission using the NR is relatively small, so the need to use the Wi-Fi and the NR together using the ATSSS technology may be reduced. Therefore, the electronic device 101 may prepare the fallback to the LTE that may support the voice service instead of maintaining the use of the NR. The electronic device 101 may acquire the ATSSS parameter including the priority-based while establishing the MA PDU session between the networks. The application processor 630 may transmit, to the communication processor 620, the signal indicating that the first condition is satisfied based on that the priority-based corresponds to the Wi-Fi.

In operation 825, the communication processor 620 may prepare the fallback from the combination of the Wi-Fi and the NR to the combination of the Wi-Fi and the LTE based on receiving the signal indicating that the first condition is satisfied.

In operation 830, the electronic device 101 may determine whether the second condition related to the disconnection of the first cellular communication is satisfied. According to an embodiment, the second condition may include the condition in which the load balancing of the first cellular communication is less than (or less than or equal to) a pre-specified level (e.g., about 10%). The electronic device 101 may acquire the ATSSS parameter including the load balancing while establishing the MA PDU session between the networks. The first cellular communication may include the new radio (NR). When the load balancing of the NR is less than the specified level, the load balancing of the NR may be lowered because the signal strength of the NR is relatively poor compared to the signal strength of the Wi-Fi, so the electronic device 101 may perform the fallback to the LTE that may support the voice service instead of maintaining the use of the NR. The application processor 630 may transmit, to the communication processor 620, the signal indicating that the second condition related to the disconnection of the first cellular communication is satisfied based on that the load balancing of the first cellular communication is less than (or less than or equal to) the pre-specified level.

In operation 832, the electronic device 101 may deactivate the ATSSS based on that the second condition is satisfied.

In operation 834, the communication processor 620 may perform the disconnection of the first cellular communication and the connection of the second cellular communication based on the reception of the signal indicating that the second condition is satisfied. The communication processor 620 may fallback from the combination of the Wi-Fi and the NR to the combination of the Wi-Fi and the LTE. The electronic device 101 may transmit data in a combination of the Wi-Fi and the LTE.

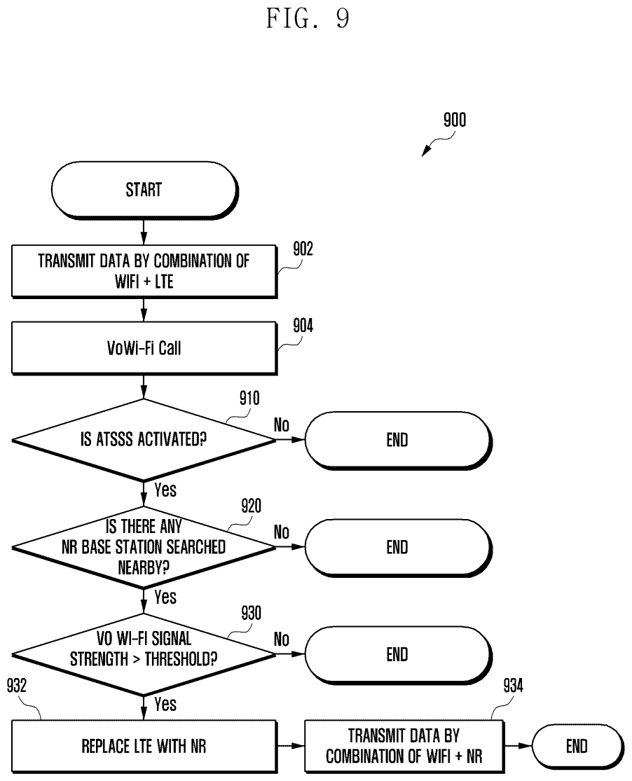

FIG. 9 is a diagram illustrating an embodiment in which the electronic device changes from the connection combination of the Wi-Fi and the second cellular communication to the connection combination of the Wi-Fi and the first cellular communication according to an embodiment of the disclosure.

The operations described with reference to FIG. 9 may be implemented based on instructions that may be stored in a computer recording medium or memory (e.g., the memory 130 of FIG. 1). An illustrated method 900 may be executed by the electronic device (e.g., the electronic device 101 of FIG. 6) described with reference to FIGS. 1 to 3, 4A to 4C, 5, and 6 above, and the technical features described above will be omitted below. The order of each operation of FIG. 9 may be changed, some operations may be omitted, and some operations may be performed simultaneously.

In operation 902, the electronic device 101 may transmit data in the combination of the Wi-Fi and the LTE.

In operation 904, the electronic device 101 may be registered with the LTE network (NW) and may be in the state capable of supporting the VoWi-Fi.

In operation 910, the electronic device 101 may determine whether the access traffic steering, switching, splitting (ATSSS) is supported. The ATSSS refers to a technology that manages traffic transmitted through the 3GPP networks (e.g., the NR and LTE) and the non-3GPP networks (e.g., the Wi-Fi). The access traffic steering refers to a technology that selects one network among the GPP networks (e.g., the NR and LTE) and the non-3GPP networks (e.g., the Wi-Fi) and transmits data through the selected network. The access traffic switching refers to a technology that transmits data to another network while transmitting data to one network. The access traffic splitting refers to a technology that distributes and transmits a single data flow using multiple networks. The electronic device 101 may determine whether to support the ATSSS through the ATSSS support indicator (ATS-IND) during the network registration process. For example, when the electronic device 101 can support the ATSSS, the ATS-IND may be displayed as 1, and when the electronic device 101 cannot support the ATSSS, the ATS-IND may be displayed as 0. This is not fixed, and the electronic device 101 may display the ATS-IND as 0 to display that the ATSSS support is possible, and the electronic device 101 may display the ATS-IND as 1 to display that the ATSSS support is not possible.

In operation 920, the electronic device 101 may check whether the NR base station is searched within a certain distance from the electronic device 101 based on that the ATSSS is supported. When the NR base station is not searched within a certain distance, the electronic device 101 may transmit data using the combination of the Wi-Fi and the LTE, and terminate the switching operation of the connected cellular communication. The electronic device 101 may display a guide screen (e.g., a user interface) that may select whether to use the data of the 3GPP and the non-3GPP simultaneously based on that the ATSSS is supported.

In operation 930, the electronic device 101 may determine whether the signal strength of the VoWi-Fi exceeds a pre-specified level based on that the NR base station is searched within a certain distance. The pre-specified level may be determined differently depending on a threshold for handover to the VoLTE. The electronic device 101 may transmit data using the combination of the Wi-Fi and the LTE based on that the measured signal strength of the VoWi-Fi is less than the threshold for the handover to the VoLTE, and terminate the switching operation of the connected cellular communication.

In operation 932, the electronic device 101 may replace the LTE with the NR based on that the measured signal strength of the VoWi-Fi exceeds the threshold for the handover to the VoLTE. In operation 934, the electronic device 101 may transmit data using the combination of the Wi-Fi and the new radio (NR). The Wi-Fi may correspond to the non-3GPP network, and the NR may correspond to the 3GPP network. The electronic device 101 may attempt cell reselection to the NR base station existing within a specified distance from the electronic device 101 by local releasing while being connected (RRC connected) to the LTE network, and may be registered with the NR network.

The electronic device may include the first communication circuit for supporting the first cellular communication and/or the second cellular communication, the second communication circuit for supporting the short-range wireless communication, the application processor, and the communication processor. The application processor may check whether the electronic device satisfies the first condition related to the disconnection of the first cellular communication in the state in which the electronic device is connected to the cellular network through the first cellular communication in a call connection status through the voice over (Vo) Wi-Fi, and transmit, to the communication processor, the signal indicating that the first condition related to the disconnection of the first cellular communication is satisfied based on that the electronic device satisfies the first condition related to the disconnection of the first cellular communication, check whether the electronic device satisfies the second condition related to the disconnection of the first cellular communication in the state in which the electronic device satisfies the first condition related to the disconnection of the first cellular communication, and transmit, to the communication processor, the signal indicating that the second condition related to the disconnection of the first cellular communication is satisfied base on that the electronic device satisfies the second condition related to the disconnection of the first cellular communication. The communication processor may prepare to disconnect the first cellular communication and connect the second cellular communication based on the reception of the signal indicating that the first condition related to the disconnection of the first cellular communication is satisfied, and may perform the disconnection of the first cellular communication and the connection of the second cellular communication based on the reception of the signal indicating that the second condition related to the disconnection of the first cellular communication is satisfied.

The first condition related to the disconnection of the first cellular communication includes the condition that the load balancing rate of the short-range wireless communication is relatively higher than the load balancing rate of the first cellular communication, and the application processor may transmit, to the communication processor, the signal indicating that the first condition is satisfied based on that the load balancing rate of the short-range wireless communication is greater than or equal to (or exceeds) the load balancing rate of the first cellular communication.

The first condition related to the disconnection of the first cellular communication includes a case where the short-range wireless communication operates in the active state and the remaining first cellular communication and/or second cellular communications operate in the standby state, and the application processor may transmit, to the communication processor, the signal indicating that the first condition is satisfied based on that the short-range wireless communication operates in the active state and the remaining first cellular communication and/or second cellular communications operate in the standby state.

The first condition related to the disconnection of the first cellular communication includes a case where the priority of the communication scheme for performing the data transmission/reception is higher for the short-range wireless communication than for the first cellular communication, and the application processor may transmit the signal to the communication processor indicating that the first condition is satisfied based on that the priority of the communication scheme for performing the data transmission/reception is higher for the short-range wireless communication than for the first cellular communication.

The second condition includes the condition that the load balancing of the first cellular communication is less than (or less than or equal to) the pre-specified level, and the application processor may transmit, to the communication processor, the signal indicating that the second condition related to the disconnection of the first cellular communication is satisfied based on that the load balancing of the first cellular communication is less than (or less than or equal to) the pre-specified level.

The first cellular communication may include the new radio (NR).

The second cellular communication may include the long-term evolution (LTE).

The electronic device may include the first communication circuit for supporting the first cellular communication and/or the second cellular communication, the second communication circuit for supporting the short-range wireless communication, the application processor, and the communication processor. The application processor may check whether the electronic device supports the access traffic steering, switching, splitting (ATSSS) in the call connection status through the voice over (Vo) Wi-Fi, determine whether the base station supporting the first cellular communication exists within a preset distance from the electronic device based on that the electronic device supports the ATSSS, determine whether the signal strength of the voice over (Vo) Wi-Fi is greater than or equal to (or exceeds) a pre-specified level based on that the base station supporting the first cellular communication exists within the preset distance from the electronic device, and transmit the signal related to the disconnection of the second cellular communication to the communication processor based on that the signal strength of the voice over (Vo) Wi-Fi is greater than or equal to (or exceeds) the pre-specified level. The communication processor may perform the disconnection of the second cellular communication and the connection of the first cellular communication based on that the signal related to the disconnection of the second cellular communication is received from the application processor.

The application processor may transmit the signal related to the disconnection of the second cellular communication to the communication processor based on that the call connection through the voice over (Vo) Wi-Fi is terminated, and the communication processor may perform the disconnection of the second cellular communication and the connection of the first cellular communication based on that the signal related to the disconnection of the second cellular communication is received from the application processor.

An operation method for an electronic device for switching an operation mode of cellular communication includes checking whether a first condition related to a disconnection of a first cellular communication is satisfied in a call connection status through voice over (Vo) Wi-Fi, transmitting, to a communication processor, a signal indicating that the electronic device satisfies the first condition related to the disconnection of the first cellular communication based on that the electronic device satisfies the first condition related to the disconnection of the first cellular communication, checking whether the electronic device satisfies a second condition related to the disconnection of the first cellular communication, in the state where the electronic device satisfies the first condition related to the disconnection of the first cellular communication, transmitting, to the communication processor, a signal indicating that the electronic device satisfies the second condition related to the disconnection of the first cellular communication based on that the electronic device satisfies the second condition related to the disconnection of the first cellular communication, preparing to disconnect the first cellular communication and connect the second cellular communication based on reception of a signal indicating that the first condition related to the disconnection of the first cellular communication is satisfied, and performing the disconnection of the first cellular communication and the connection of the second cellular communication based on reception of a signal indicating that the second condition related to the disconnection of the first cellular communication is satisfied.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a first communication circuit that supports at least one of first cellular communication or second cellular communication;
a second communication circuit that supports short-range wireless communication;
memory, comprising one or more storage media, storing instructions;
at least one application processor coupled to the memory; and
at least one communication processor coupled to the memory,
wherein the instructions, when executed by the at least one application processor, cause the electronic device to:
check whether the electronic device satisfies a first condition related to a disconnection of the first cellular communication, in a state in which the electronic device is connected to a cellular network through the first cellular communication, in a call connection status through voice over (Vo) wireless fidelity (Wi-Fi),
transmit, to the at least one communication processor, a signal indicating that the electronic device satisfies the first condition related to the disconnection of the first cellular communication based on that the electronic device satisfies the first condition related to the disconnection of the first cellular communication,
check whether the electronic device satisfies a second condition related to the disconnection of the first cellular communication, in the state where the electronic device satisfies the first condition related to the disconnection of the first cellular communication, and
transmit, to the at least one communication processor, a signal indicating that the electronic device satisfies the second condition related to the disconnection of the first cellular communication based on that the electronic device satisfies the second condition related to the disconnection of the first cellular communication, and
wherein the instructions, when executed by the at least one communication processor, cause the electronic device to:
prepare to disconnect the first cellular communication and connect the second cellular communication based on reception of the signal indicating that the first condition related to the disconnection of the first cellular communication is satisfied, and
disconnect the first cellular communication and connect the second cellular communication based on reception of the signal indicating that the second condition related to the disconnection of the first cellular communication is satisfied.

2. The electronic device of claim 1,
wherein the first condition related to the disconnection of the first cellular communication includes a condition that a load balancing rate of the short-range wireless communication is relatively higher than a load balancing rate of the first cellular communication, and
wherein the instructions, when executed by at least one the application processor, further cause the electronic device to:
transmit, to the at least one communication processor, the signal indicating that the first condition is satisfied based on that the load balancing rate of the short-range wireless communication is greater than or equal to the load balancing rate of the first cellular communication.

3. The electronic device of claim 2,
wherein the first condition related to the disconnection of the first cellular communication includes a case where the short-range wireless communication operates in an active state and at least one of remaining first cellular communications or second cellular communications operate in a standby state, and
wherein the instructions, when executed by at least one the application processor, further cause the electronic device to:
transmit, to the at least one communication processor, the signal indicating that the first condition is satisfied based on that the short-range wireless communication operates in the active state and the at least one of remaining first cellular communications or second cellular communications operate in the standby state.

4. The electronic device of claim 3,
wherein the first condition related to the disconnection of the first cellular communication includes a case where a priority of a communication scheme for performing data transmission/reception is higher for the short-range wireless communication than for the first cellular communication, and
wherein the instructions, when executed by at least one the application processor, further cause the electronic device to:
transmit, to the at least one communication processor, the signal indicating that the first condition is satisfied based on that the priority of the communication scheme for performing the data transmission/reception is higher for the short-range wireless communication than for the first cellular communication.

5. The electronic device of claim 1,
wherein the second condition includes a condition that load balancing of the first cellular communication is less than or equal to a pre-specified level, and
wherein the instructions, when executed by the at least one application processor, further cause the electronic device to:
transmit, to the at least one communication processor, the signal indicating that the second condition related to the disconnection of the first cellular communication is satisfied based on that the load balancing of the first cellular communication is less than or equal to the pre-specified level.

6. The electronic device of claim 1, wherein the first cellular communication includes new radio (NR).

7. The electronic device of claim 1, wherein the second cellular communication includes long-term evolution (LTE).

8. An electronic device, comprising:
a first communication circuit that supports at least one of first cellular communication or second cellular communication;
a second communication circuit that supports short-range wireless communication;
memory, comprising one or more storage media, storing instructions;
at least one application processor coupled to the memory; and
at least one communication processor coupled to the memory,
wherein the instructions, when executed by the at least one application processor, cause the electronic device to:
check whether the electronic device supports access traffic steering, switching, splitting (ATSSS), in a call connection status through voice over (Vo) wireless fidelity (Wi-Fi),
determine whether a base station supporting the first cellular communication exists within a preset distance from the electronic device based on that the electronic device supports the ATSSS,
determine whether a signal strength of the Vo Wi-Fi is greater than or equal to a pre-specified level based on that the base station supporting the first cellular communication exists within the preset distance from the electronic device, and
transmit, to the at least one communication processor, a signal related to a disconnection of the second cellular communication based on that the signal strength of the Vo Wi-Fi is greater than or equal to the pre-specified level, and
wherein the instructions, when executed by the at least one communication processor, cause the electronic device to:
disconnect the second cellular communication and connect the first cellular communication based on a signal related to the disconnection of the second cellular communication received from the application processor.

9. The electronic device of claim 8,
wherein the instructions, when executed by the at least one application processor, further cause the electronic device to transmit, to the at least one communication processor, the signal related to the disconnection of the second cellular communication based on that a call connection through the Vo Wi-Fi is terminated, and
wherein the instructions, when executed by the at least one communication processor, further cause the electronic device to disconnect the second cellular communication and connect the first cellular communication based on that the signal related to the disconnection of the second cellular communication is received from the application processor.

10. The electronic device of claim 8, wherein the first cellular communication includes new radio (NR).

11. The electronic device of claim 8, wherein the second cellular communication includes long-term evolution (LTE).

12. A method performed by an electronic device for switching an operation mode of cellular communication, the method comprising:
checking whether a first condition related to a disconnection of a first cellular communication is satisfied in a call connection status through voice over (Vo) wireless fidelity (Wi-Fi);
transmitting, to at least one communication processor, a signal indicating that the electronic device satisfies the first condition related to the disconnection of the first cellular communication based on that the electronic device satisfies the first condition related to the disconnection of the first cellular communication;
checking whether the electronic device satisfies a second condition related to the disconnection of the first cellular communication, in a state where the electronic device satisfies the first condition related to the disconnection of the first cellular communication;
transmitting, to the at least one communication processor, a signal indicating that the electronic device satisfies the second condition related to the disconnection of the first cellular communication based on that the electronic device satisfies the second condition related to the disconnection of the first cellular communication;
preparing to disconnect the first cellular communication and connect a second cellular communication based on reception of the signal indicating that the first condition related to the disconnection of the first cellular communication is satisfied; and
disconnecting the first cellular communication and connecting the second cellular communication based on reception of the signal indicating that the second condition related to the disconnection of the first cellular communication is satisfied.

13. The method of claim 12,
wherein the first condition related to disconnection of the first cellular communication includes a condition that a load balancing rate of a short-range wireless communication is relatively higher than a load balancing rate of the first cellular communication, and
wherein the transmitting of, to the at least one communication processor, the signal indicating that the electronic device satisfies the first condition related to the disconnection of the first cellular communication based on that the electronic device satisfies the first condition related to the disconnection of the first cellular communication further includes transmitting, to the at least one communication processor, the signal indicating that the first condition is satisfied based on that the load balancing rate of the short-range wireless communication is greater than or equal to the load balancing rate of the first cellular communication.

14. The method of claim 13,
wherein the first condition related to the disconnection of the first cellular communication includes a case where the short-range wireless communication operates in an active state and at least one of remaining first cellular communications or second cellular communications operate in a standby state, and
wherein the transmitting of, to the at least one communication processor, the signal indicating that the electronic device satisfies the first condition related to the disconnection of the first cellular communication based on that the electronic device satisfies the first condition related to the disconnection of the first cellular communication further includes transmitting, to the at least one communication processor, the signal indicating that the first condition is satisfied based on that the short-range wireless communication operates in the active state and the at least one of remaining first cellular communications or second cellular communications operate in the standby state.

15. The method of claim 14,
wherein the first condition related to the disconnection of the first cellular communication includes a case where a priority of a communication scheme for performing data transmission/reception is higher for the short-range wireless communication than for the first cellular communication, and
wherein the transmitting of, to the at least one communication processor, the signal indicating that the electronic device satisfies the first condition related to the disconnection of the first cellular communication based on that the electronic device satisfies the first condition related to the disconnection of the first cellular communication further includes transmitting, to the at least one communication processor, the signal indicating that the first condition is satisfied based on that the priority of the communication scheme for performing the data transmission/reception is higher for the short-range wireless communication than for the first cellular communication.

16. The method of claim 12,
wherein the second condition includes a condition that load balancing of the first cellular communication is less than or equal to a pre-specified level, and
wherein the transmitting of, to the at least one communication processor, the signal indicating that the electronic device satisfies the second condition related to the disconnection of the first cellular communication based on that the electronic device satisfies the second condition related to the disconnection of the first cellular communication further includes transmitting, to the at least one communication processor, the signal indicating that the second condition related to the disconnection of the first cellular communication is satisfied based on that the load balancing of the first cellular communication is less than or equal to the pre-specified level.

17. The method of claim 12, wherein the first cellular communication includes new radio (NR).

18. The method of claim 12, wherein the second cellular communication includes long-term evolution (LTE).

19. One or more non-transitory computer-readable storage media storing one or more computer programs including computer-executable instructions that, when executed by one or more processors of an electronic device individually or collectively, cause the electronic device to perform operations, the operations comprising:
checking whether a first condition related to a disconnection of a first cellular communication is satisfied in a call connection status through voice over (Vo) wireless fidelity (Wi-Fi);
transmitting, to at least one communication processor, a signal indicating that the electronic device satisfies the first condition related to the disconnection of the first cellular communication based on that the electronic device satisfies the first condition related to the disconnection of the first cellular communication;
checking whether the electronic device satisfies a second condition related to the disconnection of the first cellular communication, in a state where the electronic device satisfies the first condition related to the disconnection of the first cellular communication;
transmitting, to the at least one communication processor, a signal indicating that the electronic device satisfies the second condition related to the disconnection of the first cellular communication based on that the electronic device satisfies the second condition related to the disconnection of the first cellular communication;
preparing to disconnect the first cellular communication and connect a second cellular communication based on reception of the signal indicating that the first condition related to the disconnection of the first cellular communication is satisfied; and
disconnecting the first cellular communication and connecting the second cellular communication based on reception of the signal indicating that the second condition related to the disconnection of the first cellular communication is satisfied.

20. The one or more non-transitory computer-readable storage media of claim 19, the operations further comprising:
transmitting, to the at least one communication processor, the signal indicating that the first condition is satisfied based on that a load balancing rate of a short-range wireless communication is greater than or equal to a load balancing rate of the first cellular communication.
